(19) United States
(12) Patent Application Publication
(10) Pub. No.: US 2026/0036888 A1
(43) Pub. Date: Feb. 5, 2026

(54) MOTOR VEHICLE WITH AN ADJUSTABLE CAMERA ARRANGED IN THE REAR REGION

(71) Applicant: Dr. Ing. h.c. F. Porsche Aktiengesellschaft, Stuttgart (DE)

(72) Inventor: Bogdan PENTIA, Ostfildern (DE)

(21) Appl. No.: 19/277,423

(22) Filed: Jul. 23, 2025

(30) Foreign Application Priority Data
Aug. 2, 2024 (DE) 10 2024 122 122.4

(51) Int. Cl. G03B 17/56

(52) U.S. Cl. CPC G03B 17/561

(57) ABSTRACT

A motor vehicle includes a rear region, in which a camera configured to be adjusted at least between a first position and a second position is arranged for capturing a predefined capture region. The rear region includes at least one predefined load case region. The camera is arranged outside of the at least one predefined load case region. The camera is configured so as to capture the predefined capture region before and after a predefined load acting on the predefined load case region.

### CROSS REFERENCE TO RELATED APPLICATIONS

This application claims benefit to German Patent Application No. DE 10 2024 122 122.4, filed on Aug. 2, 2024, which is hereby incorporated by reference herein.

### FIELD

The present invention relates to a motor vehicle having a rear region, in which a camera that can be adjusted at least between a first position and a second position is arranged for capturing a predefined capture region.

### BACKGROUND

From DE 10 2017 119 832 A1, a generic motor vehicle with a rear region is known, in which a camera that can be adjusted at least between a first position and a second position is arranged for capturing a predefined capture region. The camera is adjustable between a body roof and a rear window by means of a position change device.

From DE 10 2014 109 930 A1, a camera unit for a motor vehicle having a carrier housing is known, which is arranged in a breakthrough of an outer trim of the motor vehicle. Further provided is a power unit, which is connected to the carrier housing and coupled to a movably mounted camera. The power unit is able to move the camera from out of a first position in which it is covered by a protective cover and into a second position which is closer to the protective cover. The protective cover comprises a deformable, elastic sealing device, which at least partially sealingly closes an opening in the protective cover, provided the camera is in its first position. When moving into the second position, the camera at least partially deforms the sealing device and projects partially through the sealing device.

From U.S. Pat. No. 11,815,595B2, a vehicle sensor mounting structure is known, comprising a first and a second set of sensors, each having a sensor group including a plurality of sensors. The respective sensor group is mounted via a bracket.

A disadvantage in motor vehicles with a camera system arranged in the rear region as previously known from the prior art is that the motor vehicles must comply with country-specific statutory load trials, for example load case notch tests (US PART 581) or wall crashes. Such load trials can lead to a displacement of a camera of the camera system, whereby the camera no longer captures the intended and predefined capture region and, as a result, prevents autonomous driving in particular. This can be circumvented, for example, in that the camera is arranged outside of a so-called load case region, in which an impact is to be expected during the respective statutory load trials. However, if the camera is positioned outside of the predefined load case region, this can, for example, lead to it no longer capturing a predefined capture region and thereby no longer fulfilling a function of active intervention in a braking behavior, for example. Particular attention is paid to a non-permissible deviation of the camera capture after the load case and active intervention in the braking behavior when driving in reverse.

### SUMMARY

In an embodiment, the present disclosure provides a motor vehicle including a rear region, in which a camera configured to be adjusted at least between a first position and a second position is arranged for capturing a predefined capture region. The rear region includes at least one predefined load case region. The camera is arranged outside of the at least one predefined load case region. The camera is configured so as to capture the predefined capture region before and after a predefined load acting on the predefined load case region.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a longitudinal section through a motor vehicle according to an embodiment of the present invention in a rear region;

FIG. 2 shows a view of the motor vehicle according to an embodiment of the present invention, with the camera located in its first position; and

FIG. 3 shows a representation as in FIG. 1, but with the camera located in its second position.

### DETAILED DESCRIPTION

Embodiments of the present invention therefore address the problem of providing an improved or at least an alternative embodiment for a motor vehicle of said type, by means of which the disadvantages known from the prior art can be at least partially overcome.

Embodiments of the present invention are based on the general idea of first placing a camera in a rear region of a motor vehicle in such a way that it lies outside of a predefined load case region and, as a result, with a predefined load acting on this predefined load case region, for example a load resulting from legally prescribed load trials, such as in a particular embodiment a notch test, further captures its predefined capture region. The motor vehicle according to an embodiment of the present invention has a rear region in which a camera, which is adjustable at least between a first position and a second position, is arranged for capturing the predefined capture region. The rear region further has at least one predefined load case region, wherein the adjustable camera is arranged outside of this at least one predefined load case region. This offers the great advantage that, in case of a load that acts on the predefined load case region and is predefined, for example from a legally defined load, such as in a particular embodiment a notch test or a wall crash, no load impact on the adjustable camera occurs. The adjustable camera is further configured so as to capture the predefined capture region before and after a predefined load acting on the predefined load case region. The arrangement of a non-adjustable camera outside of the predefined load case region would also protect it from a predefined load on this load case region, but it might not capture the predefined capture region. If, by contrast, a non-adjustable camera had been arranged within the predefined load case region, however, it could capture the predefined capture region before the applied load, after the predefined load, for example after a notch test, but it may be misaligned such that it can no longer capture the predefined capture region. By means of the camera arranged outside of the predefined load case region and at the same time adjustable according to an embodiment of the present invention, a deviation of a viewing angle before and after the load can thus be avoided. The adjustability of the camera allows the camera to provide observation of the predefined capture region prior to and after impact of the predefined load on the predefined load case region.

In an advantageous further development of the motor vehicle according to an embodiment of the present invention, the camera can be pivoted about an axis, in a particular embodiment about an axis that extends in the transverse direction of the vehicle. In this way, it is possible to use the camera as a so-called rear top view camera in the first position and, for example, to use it for autonomous driving, while the camera located in its second position can be used as a rear camera and can in a particular embodiment capture a reverse roadway region behind the motor vehicle according to an embodiment of the present invention, whereby an improved maneuverability for a user of the motor vehicle is provided.

In a particularly preferred embodiment of the motor vehicle according to an embodiment of the present invention, the camera is arranged in its first position so as to be aligned flush with a trim part surrounding the camera. This offers the great advantage that the camera does not engage, or only marginally engages, with a surface design of the motor vehicle in its first position and can thereby be placed comparatively discretely. Because the camera is typically in its first position, in which it is visually unobtrusively arranged in the rear panel, there are in particular embodiments design advantages.

In an embodiment, the camera is conveniently arranged between a rear bumper and a rear spoiler of the rear trim. In this position, it is thus obscured from above by the rear spoiler and still has a comparatively large field of view backward and downward. In addition, the arrangement of the camera between the rear bumper and the rear spoiler can achieve an arrangement outside of the at least one predefined load case region, i.e., in the present case above the predefined load case regions, so that the camera preferably remains unaffected in case of a predefined load impacting the predefined load case region.

In an embodiment, the camera is conveniently arranged on an upper edge of the rear bumper. This allows the camera to be placed surface-flush in its first position, thus being visually nearly discrete, while being pivoted out in its second position and thereby allowing an improved range of vision on a reverse roadway. In the first position, the camera can thus be used when driving forward, also for autonomous driving if necessary. The camera is retracted during forward travel and is not used. However, when driving backwards, the camera extends into its second position, but is protected in relation to the impact, because it lies outside of the region affected by the oscillation.

In a particularly preferred embodiment of the motor vehicle according to an embodiment of the present invention, a computer device for at least semi-autonomous driving is provided, wherein the camera is communicatively connected to the computer device. In autonomous driving, an all-around view about the autonomously driving motor vehicle is required, so that in this case the camera can be used as a rear top view camera for autonomous driving and as a rear camera in its second position, for example for parking.

In an embodiment, the camera is conveniently arranged centrally on the motor vehicle in the transverse direction of the vehicle. This allows for a comparatively large, in particular embodiments wide, capture region to be defined so that the camera can capture comparatively a great deal in both its first position and its second position.

In a particularly preferred embodiment, the predefined load case region is determined by predefined load trials. Such predefined load trials can be, for example, legally prescribed impact tests, for example a notch test, which is carried out with a predefined load, at a predefined height, and with a predefined body. The arrangement of the camera is selected such that it lies outside of the at least one predefined load case region, wherein direct damage to the camera by, for example, an impact body can in particular be reliably avoided.

Further important features and advantages of embodiments of the present invention will emerge from the drawings and from the associated description of the figures with reference to the drawings.

It should be understood that the features specified above and those described below can be used not only in the respectively specified combination, but also in other combinations or on their own, without departing from the scope of the invention as defined by the claims. The components described above and referred to below of a higher-level unit, e.g., a device, an apparatus, or an assembly, which are indicated separately, can constitute separate parts and/or components of this unit, or integral areas and/or sections of this unit, even if the drawings show otherwise.

Preferred embodiment examples of the present invention are represented in the drawings and are explained in further detail in the description below, wherein identical reference numbers refer to identical, similar, or functionally identical components.

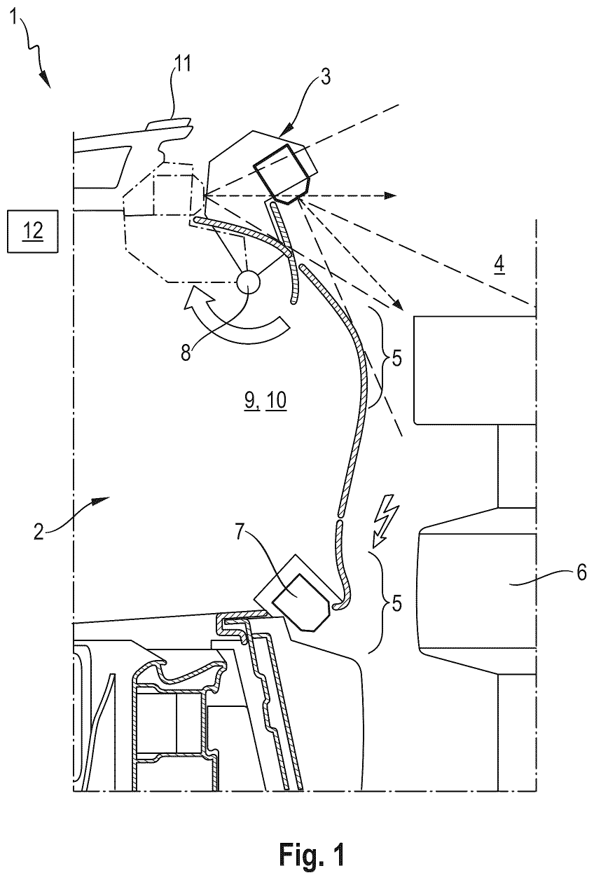

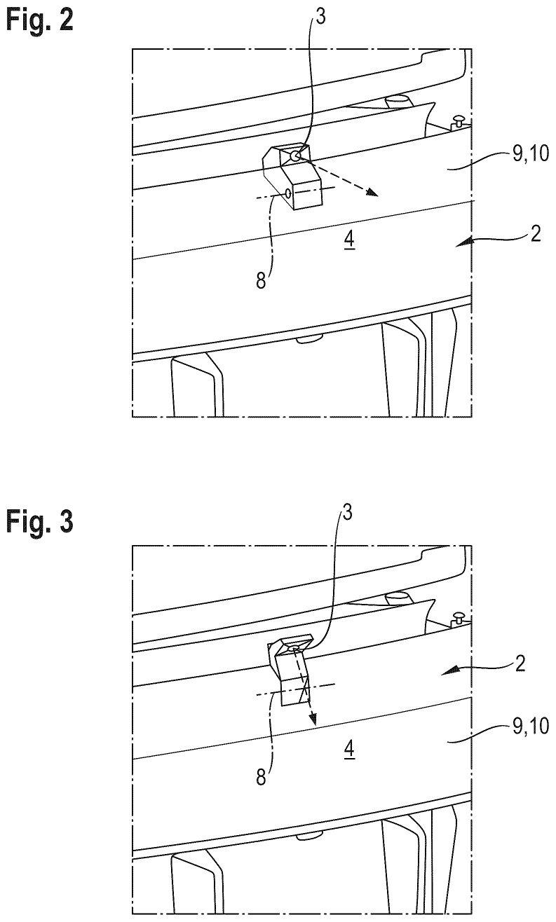

According to FIGS. 1-3, a motor vehicle 1 according to an embodiment of the present invention comprises a rear region 2, in which a camera 3 is arranged, which can be adjusted between at least between a first position (cf. FIG. 2) and a second position (cf. FIG. 3), for capturing a predefined capture region 4. In FIG. 1, the camera 3 is shown both in its first position (pivoted in) and in its second position (pivoted out). In addition, the rear region 2 comprises at least one predefined load case region 5, wherein, according to FIGS. 1-3, the camera 3 is arranged outside of, i.e., in the specific case above, the load case regions 5. The adjustable camera 3 is further configured so as to capture the predefined capture region 4 before and after a predefined load acting on the predefined load case region 5.

The predefined load case region 5 can be defined by, for example, predefined load trials with predefined impact bodies 6, for example a wall or a shock.

The load case regions 5 can be different for specific countries depending on the legal requirements for different load trials, for example with different impact bodies 6, wherein the arrangement of the camera 3 is always selected such that it lies outside of, in the present case above, the load case region 5 or the load case regions 5.

If one considers FIG. 1, it can be seen that a rear camera 7 was previously arranged in the predefined load case region 5, which was adjusted upon an impact by the impact body 6 or striking a wall, such that it could not further capture its original and preset capture region. Due to the arrangement according to an embodiment of the present invention of the pivotable camera 3 outside of, i.e., in the specific case above, the load case region 5, it is protected against a load acting on the load case region 5 and can therefore perform its function independent of a load acting on the load case region 5.

If one considers FIGS. 1 to 3 further, an axis 8 can be seen there, which extends in the transverse direction of the vehicle and about which the camera 3 can be pivoted between its first and second position.

In its first position, the camera 3 is preferably arranged so as to be aligned flush with the surface of a trim part 9 surrounding the camera 3, for example a bumper 10. This surface-flush arrangement does not impair, or only marginally impairs, a design of the rear region 2. Furthermore, the camera 3 can be arranged between the bumper 10 and a rear spoiler 11 arranged above it, in which case an arrangement of the camera 3 is provided on an upper edge of the rear bumper 10.

Moreover, the motor vehicle 1 can comprise a computer device 12 for at least semi-autonomous driving, wherein the camera 3 is communicatively connected to the computer device 12. As a result, the camera 3 can be left in its first position (cf. FIGS. 1 and 2) for at least semi-autonomous driving, for example, whereby it can be used as a so-called rear-top view camera. If the camera 3 is pivoted into its second position (cf. FIGS. 1 and 3), it can be used as a reverse driving camera, for example to park in reverse.

The camera 3 is preferably arranged centrally on the motor vehicle 1 in the transverse direction of the vehicle, whereby a comparatively wide capture region 4 perpendicular to the image plane shown in FIG. 1 is possible.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A motor vehicle comprising a rear region, in which a camera configured to be adjusted at least between a first position and a second position is arranged for capturing a predefined capture region,
wherein the rear region comprises at least one predefined load case region,
wherein the camera is arranged outside of the at least one predefined load case region, and
wherein the camera is configured so as to capture the predefined capture region before and after a predefined load acting on the predefined load case region.

2. The motor vehicle according to claim 1, wherein the camera is configured to be pivoted about an axis.

3. The motor vehicle according to claim 2, wherein the axis extends in a transverse direction of the motor vehicle.

4. The motor vehicle according to claim 1, wherein in its first position, the camera is arranged so as to be aligned flush with a surface of a trim part surrounding the camera.

5. The motor vehicle according to claim 1, wherein the camera is arranged between a rear bumper and a rear spoiler.

6. The motor vehicle according to claim 5, wherein the camera is arranged on an upper edge of the rear bumper.

7. The motor vehicle according to claim 1, wherein a computer device is provided for at least semi-autonomous driving, and wherein the camera is communicatively connected to the computer device.

8. The motor vehicle according to claim 1, wherein the camera is arranged centrally on the motor vehicle in a transverse direction of the vehicle.

9. The motor vehicle according to claim 1, wherein the at least one predefined load case region is determined based on predefined load trials.
